(19) United States
(12) Patent Application Publication
(10) Pub. No.: US 2015/0293582 A1
(43) Pub. Date: Oct. 15, 2015

(54) Energy Efficient Blade Server and Method for Reducing the Power Consumption of a Data Center Using the Energy Efficient Blade Server

(71) Applicants: Pierre Popovic, Laval (CA); Daniel Massicotte, Trois-Rivieres (CA)

(72) Inventors: Pierre Popovic, Laval (CA); Daniel Massicotte, Trois-Rivieres (CA)

(21) Appl. No.: 14/687,683

(22) Filed: Apr. 15, 2015

Related U.S. Application Data
(60) Provisional application No. 61/979,627, filed on Apr. 15, 2014.

(51) Int. Cl. G06F 1/32; H04L 12/24

(52) U.S. Cl. CPC G06F 1/3287; H04L 41/0833; H04L 41/0806

(57) ABSTRACT

An energy efficient blade server and a method for reducing the power consumption of data centers using said energy efficient blade server. The energy efficient blade server receives a process through a front-end processing unit and determines a specific processing resource tier from a plurality of processing resource tiers according to a green energy efficiency value, wherein the green energy efficiency value the most efficient processing resource tier for the process. The front-end processing tier notifies a power management control tier to power on the specific processing resource tier through a tier power control device, wherein the process is then transferred from the front-end processing tier to the specific processing resource tier. The green energy efficiency value is determined according to a number of parameters monitored by a plurality of monitoring components of the power management control tier.

The current application claims a priority to the U.S. Provisional Patent application Ser. No. 61/979,627 filed on Apr. 15, 2014.

### FIELD OF THE INVENTION

The present invention relates generally to the field of data centers, blade servers, and the processing of heterogeneous applications in data centers. More specifically, the present invention relates to non-hierarchical multi-tier heterogeneous parallel multi-processor blade server architectures and the smart methods implemented for managing, sequencing, and monitoring the energy consumption of computing resources.

### BACKGROUND OF THE INVENTION

The insatiable worldwide appetite for instant access to information, video, communication, cloud computing, the Internet of things, and social networking on any portable device vastly increases the amount of energy consumed by data centers. The accessibility and availability of data centers are becoming ever more important and the number, power densities, and size of data centers are growing fast.

This growth has been further fuelled by newer concepts such as cloud computing and a plethora of new data center related services such as software as a service (SaaS), platform as a service (PaaS), infrastructure as a service (IaaS), information technology (IT) as a service (ITaaS), and pay-as-you-go IT services. Data center business has grown from basic searches, database queries, e-mail, and web-hosting to include a large variety of heterogeneous Internet-based business applications, customer relations, enterprise resource planning, and a multitude of office related software. The technical foundations of cloud computing include the “as-a-Service” usage model, service-oriented architecture (SOA) and virtualization of hardware and software.

The goal of cloud computing is to consolidate infrastructure, and share resources among the cloud service consumers social networking sites, and multimedia applications that require more computing power and faster processes. In responding to the increased demands and wide scope of heterogeneous applications, data center infrastructure management (DCIM) development strategies are relying on low-cost homogeneous multi-core x86 instruction set architecture (ISA) based servers. These architectures, even though they may not be the optimum architectures for heterogeneous applications, have dominated the data center market and have largely become a de facto standard. To maintain a guaranteed level of service, data centers overprovision and build redundancy in their server farms, which leads to increased consumption of both materials and energy. The result is that data centers keep their server farms operating at all times even when there is little or no computing traffic. This wastes much energy and natural resources and is detrimental to sustainability.

Communication between blade servers and the data center access layer is a fundamental function of blade servers' network interface controllers and the efficiency of any server is also linked to how quickly and efficiently data can be moved from blades to the top-of-rack (TOR) switch and onto the data center access layer. Considering the volume of data traffic it follows that each blade server has a dedicated network interface controller (NIC) to transmit data provided by the blade server processing unit and multi-processing units to the TOR switch. Multi-core and multi-processing blade servers generate a high rate of large segment data traffic volume and, to compensate for the lack of physical NICs, manufacturers frequently use virtualization to replicate several NICs on one physical NIC. The NICs, depending on their transmission speeds, cabling structure, and voltage are powered continuously and consume energy even in their idle mode. These idle energy levels can vary between 4.6 and 21.2 watts and that could represent, including data center infrastructure overhead, in the range of 12 megawatts to 60 megawatts for idle times only, per year and for an average data center.

Power efficiency and minimizing power usage are important issues in networked systems such as blade servers in data centers. Programs which monitor the usage of various components of a computer system and shut down or minimize temporarily some of those components have been used in the past. However, one area in which such power conservation has not been utilized is with respect to NIC units' power management. Optimizing NICs' power efficiency and power modes has not been previously addressed. An aspect of prior art is that there is no consideration given specifically to the power management of the actual NIC. In addition, the outgoing data flow traffic from a given blade server is directed to the TOR switch through a dedicated blade server single NIC, which may be virtualized in some embodiments. There are other NICs on a server and these are dedicated for out-of-band management and not for communication with the TOR switch. This condition is such that performance improvements and power usage optimization that may have occurred through prior art embodiments may be offset by potential sequential dataflow bottlenecks and slowdown through the NIC, the TOR switch, or at the network level.

Methods have been disclosed in the past, introducing a power management controller of a platform and power management guidelines based on one or more components maximum latency tolerances. The power management guidelines and policy of such a system determine a minimum of the maximum latency tolerances of components to determine one or more consumption levels such as “sleep” but not a power mode off state. Another aspect of prior art, are methods and techniques of optimizing power efficiency with network processors (also known as network adapters or NICs) by using novel power saving algorithms for minimal energy operations. However, one area in which such power conservation has not been utilized is with respect to integrating the NIC in an embedded processing resource tier (PRT) power management scheme, such as in the present invention.

The fundamental energy problems of data centers oblige technology suppliers to explore ways to reduce energy consumed by data centers without restricting the sprawling communication networks, cloud computing or internet business. This has given rise to several methods and systems that can save energy largely by leveraging processors' power modes. Prior art and patents in the field of power modes management and workload performance for data center servers primarily control and manage servers' power through various similar approaches and means that, in practically all embodiments cited in prior arts, share the same fundamental commonalities. These commonalities include areas such as, among others, homogeneous system architectures, tasks allocation, power level queuing, sleep tasks scheduling, workload sharing, and workload spreading.

Therefore it is the object of the present invention to reduce data center computing infrastructures' overall energy costs as well as optimize the performance of data centers' heterogeneous application processes. The present invention pertains to the field of data centers, blade servers, and parallel processing of heterogeneous applications in data centers. More precisely, the present invention relates to a system of smart methods for managing, sequencing, and monitoring energy and the consumption of computing resources in non-hierarchical multi-tier heterogeneous parallel multi-processor blade server architectures with variable, scalable and selectable power schemes. The present invention matches processes to specific optimum PRTs selected according to their greatest green energy efficiency. Every PRT is a server in itself with all the associated components, wherein the PRT is in an off state, unless otherwise turned on by the system. The selected optimum PRT is one of a plurality of processing resource tiers that could be on the same blade server and alternately, should all tiers of a blade server be busy, the process would be directed to a similar PRT either on the same blade server or to another blade server tier in the same enclosure.

In the present invention, the potential bottleneck or slowdown of dataflow has been removed as every PRT in the blade server has its dedicated physical and non-virtualized NIC and hence direct high throughput access to the TOR switch and ultimately to the data center access layer and therefore a higher throughput per blade server. The integrated NIC of each PRT is supplied power by the PRT power plane, which is in turn powered on by a tier power control device controlled by a power management controller tier in the blade server front-end processing tier. When a PRT is in a power mode off state, the NIC embedded in the PRT is in an off state as well. This strategy, maintains the PRT and the integrated plurality of components, NIC included, in a power mode off state except when required by an application.

### BRIEF DESCRIPTION OF THE DRAWINGS

FIG. 1 is schematic diagram of the electronic connections between the front-end processing unit and the power management control tier.

FIG. 2 is a schematic view of the electronic connections of a processing resource tier from the plurality of processing resource tiers.

FIG. 3 is a schematic view of the electronic connections between the front-end processing tier, the power management control tier, and the plurality of processing resource tiers.

FIG. 4 is a flowchart depicting steps for selecting and running a process on a specific processing resource tier from the plurality of processing resource tiers;

FIG. 5 is a flowchart thereof, further depicting steps for searching for a process name in a green energy predictor table;

FIG. 6 is a flowchart thereof, further depicting steps for matching the process name to a green energy efficiency value and in turn the specific processing resource tier;

FIG. 7 is a flowchart thereof, further depicting steps for selecting a default processing resource tier if the process name is not identified;

FIG. 8 is a flowchart thereof, further depicting steps for utilizing processing resource tier identity information to select the specific processing resource tier;

FIG. 9 is a flowchart thereof, further depicting steps for performing a liveness test by the specific resource tier to prior to receiving the process;

FIG. 10 is a flowchart thereof, further depicting steps for transferring the process and entering the front-end processing tier into an idle state; and

FIG. 11 is a flowchart thereof, further depicting steps for running a sub-process of the process on a virtual processing element.

FIG. 12 is a flowchart depicting the steps taken by the master command control module to identify the specific processing resource tier on which the process should be run.

### DETAIL DESCRIPTIONS OF THE INVENTION

All illustrations of the drawings are for the purpose of describing selected versions of the present invention and are not intended to limit the scope of the present invention.

The term “heterogeneous”, as used to describe the present invention, refers to multi-processors that may have multi-core systems that may use different and sometimes incompatible instruction set architecture (ISA) that may lead to binary incompatibility, that may interpret memory in different ways, and that may have different application binary interfaces (ABIs) and/or application programming interfaces (APIs).

The term “monitor”, as used to describe the present invention, means collecting and storing data. For example a monitoring component, or a component that monitors, will collect data in regards to temperatures, energy used, or fan speeds and store the information in a given storage area.

In the present invention, the term “power mode” is associated with an entire processing tier unless otherwise and specifically specified. Furthermore, for the purpose of the present invention, power mode “off” is a state that means that no energy is consumed and the device is not using power of any kind, while power mode “on” is a state that means energy is consumed. Power mode on can include any number of common consumption modes in which energy is being consumed, such as “low”, “sleep”, or “deep sleep” modes; the value of which depends on processors, manufacturers, or other specifications.

Furthermore, in the present invention, a process is defined as an instance of a computer program that is being executed, and contains the program code and its current activity. A process may be made up of multiple threads of execution that execute instructions concurrently. A computer program is a passive collection of instructions; a process is the actual execution of those instructions.

In addition, the terms “component,” “module,” “system,” “processing component,” “processing engine” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer.

While the term “tier” implies a multi-level or multi-layer hierarchy in a given order, in the present invention, a processing resource tier (PRT) is defined as a non-hierarchical, independent, stand-alone, and complete processing resource system embedded in the main blade server architecture.

The present invention is a computer system, methods, apparatus and computer readable medium to reduce data centers' energy costs and improve the data centers' computing infrastructures' green energy efficiency and workload performance of the data centers' application processes. This is accomplished by executing the application processes on a blade server system with embedded, non-hierarchical heterogeneous multi-processors, and scalable parallel processing resource tiers optimized for energy-efficiency and performance delivery. In this disclosure, green energy efficiency of a computing resource is defined as a function of reduced power, reduced heat dissipation, reduced process execution times, and increased process workload performance delivery.

The present invention provides a blade server system (i.e. computer system) having a plurality of energy efficient blade servers being interconnected to each other. Each of the plurality of energy efficient blade servers is a multi-processor single board blade server technology that can be heterogeneous in some embodiments, as well as homogeneous in other embodiments. Each of the plurality of energy efficient blade servers is implemented with accompanying methods that together result in a significant reduction in data center energy costs, improve the computing infrastructures' green energy efficiency and workload performance of application processes, and reduce the overall power consumption of data center servers and of data center infrastructures.

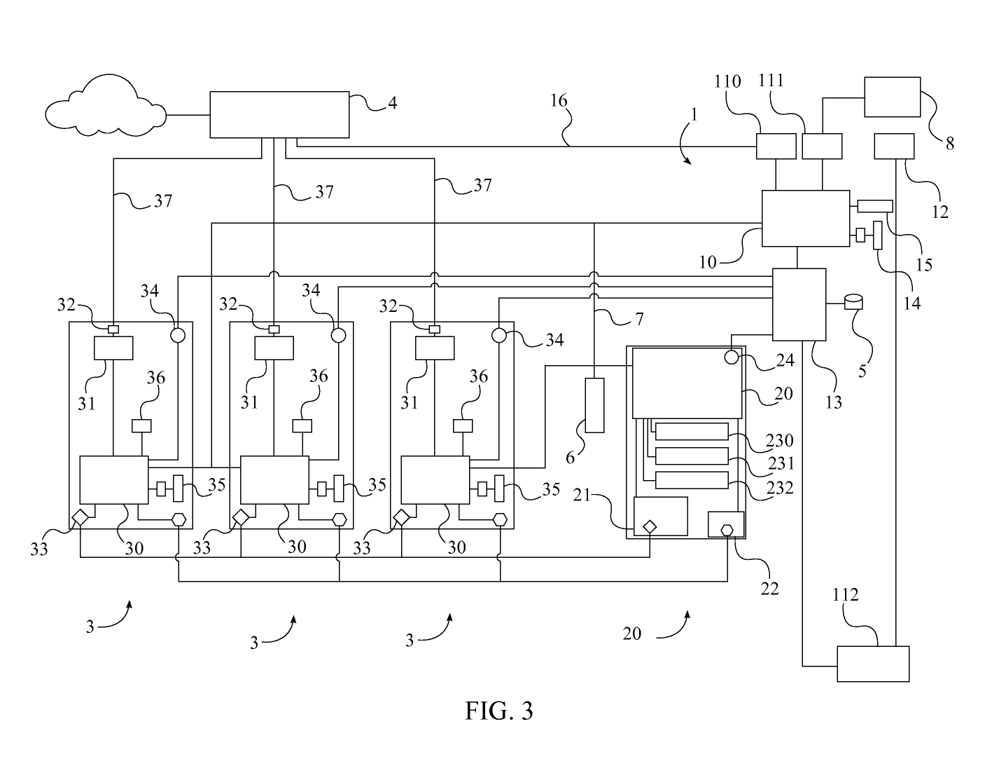

In reference to FIG. 3, an energy efficient blade server from the plurality of energy efficient blade servers comprises a front-end processing tier (FPT) 1, a plurality of PRTs 3, and a power management control tier (PMCT) 2. The present invention also provides a related computer program product, loadable in the memory of at least one PRT from the plurality of PRTs 3, the FPT 1, or the PMCT 2, wherein the related computer program product includes software code portions for performing the steps of the method of the present invention when the related computer program product is run on the energy efficient blade server. As used herein, reference to the related computer program product is intended to be equivalent to reference to a computer-readable medium containing instructions that may control a PRT from the plurality of PRTs 3, the FPT 1, or the PMCT 2 that may control the energy efficient blade server, which may control integrated elements, which may coordinate various management schemes and performance of the method of the present invention. Reference to at least one PRT is intended to highlight the possibility for the present invention to be implemented in a distributed and/or modular and/or parallel fashion. In the context of this patent application, parallel processing occurs when several PRTs process processes independently from one another and transmit the process results to a top-of-rack (TOR) switch 4 through the network interface controller (NIC) of each of the PRTs.

The term “top-of-rack” is used (coined) as these switches actual physical location may often be in top of the server rack enclosure. However, the actual physical location of the TOR switch 4 does not necessarily need to be at the top of the rack and may be located in another position in the rack, such as the bottom or the middle. Top of the rack position is the most common due to easier accessibility and cable management. The TOR switch 4 directly links the rack to the data center common aggregation area connecting to redundant “distribution” or “aggregation” high density modular Ethernet switches, or other variations of local area network (LAN) switches. In the preferred embodiment of the present invention the TOR switch 4 is an Ethernet switch, however, another type of LAN switch may be used in other embodiments of the present invention.

In the following description of the energy efficient blade server, details are set forth in order to provide an understanding of various embodiments. However, various embodiments of the present invention may be practiced without specific details. Well-known methods, procedures, components, and circuits have not been described in detail so as not to obscure the particular embodiments of the present invention.

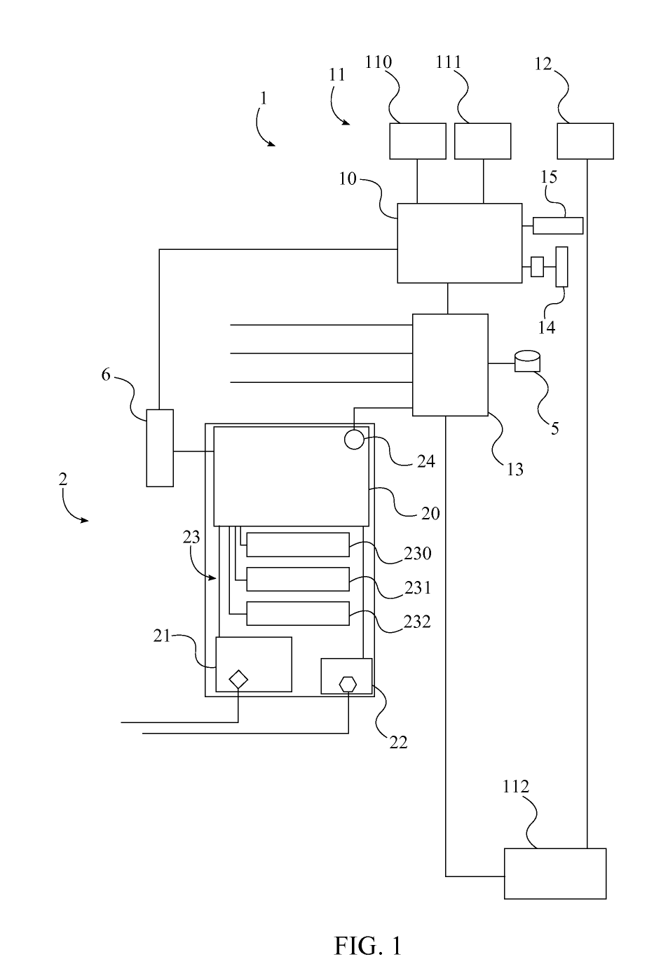

In reference to FIG. 1, the FPT 1 is the main server board, or main blade server architecture, of the energy efficient blade server, and comprises a general purpose processor (GPP) 10, a plurality of NICs 11, an input/output (I/O) hub 13, a FPT memory 14, a FPT storage 15, a LAN port 12, an operating system, and software tools. The FPT 1 is the processing system that initially handles a process before transferring the process execution to a PRT from the plurality of PRTs 3. The GPP 10 is connected to the plurality of PRTs 3 through a hub and a bus. The GPP 10 shares a common main memory 6 in the form of a random access memory (RAM) with the plurality of PRTs 3 and may additionally share a common computer readable storage medium 5 with the plurality of PRTs 3.

The GPP 10 may comprise a single processor or the GPP 10 may include a processing device comprising: a processing module capable of multitasking multiple tasks; one or more associated circuits, which may be selectively configured responsive to control signals, coupled to said processing module for supporting the processing module; and a memory storing a control words for configuring the associated circuits, additional memory, network controllers, I/O ports, and functions as a server.

In the preferred embodiment of the present invention, the plurality of NICs 11 comprises a dedicated TOR NIC 110, an inter-server NIC 111, and a smart out-of-band management (SOM) controller 112, as depicted in FIG. 1. Each of the plurality of NICs 11 is electronically connected to the GPP 10 and allows the FPT 1 to communicate with outside networks. The dedicated TOR NIC 110 and the inter-server NIC 111 are both high rate NICs, while the SOM controller 112 is a lower rate NIC. The dedicated TOR NIC 110 is electronically connected to the TOR switch 4 and allows the FPT 1 to communicate process results to the TOR switch 4 and on to the data center access layer network. The inter-server NIC 111 is electronically connected to an at least one subsequent energy efficient blade server 8 in the same rack as the energy efficient blade server, allowing the blade servers within the rack to share data with each other. The SOM controller 112 is electronically connected to the LAN port 12 in order to provide data center managers with remote power control management and monitoring, and enables a remote console for the energy efficient blade server.

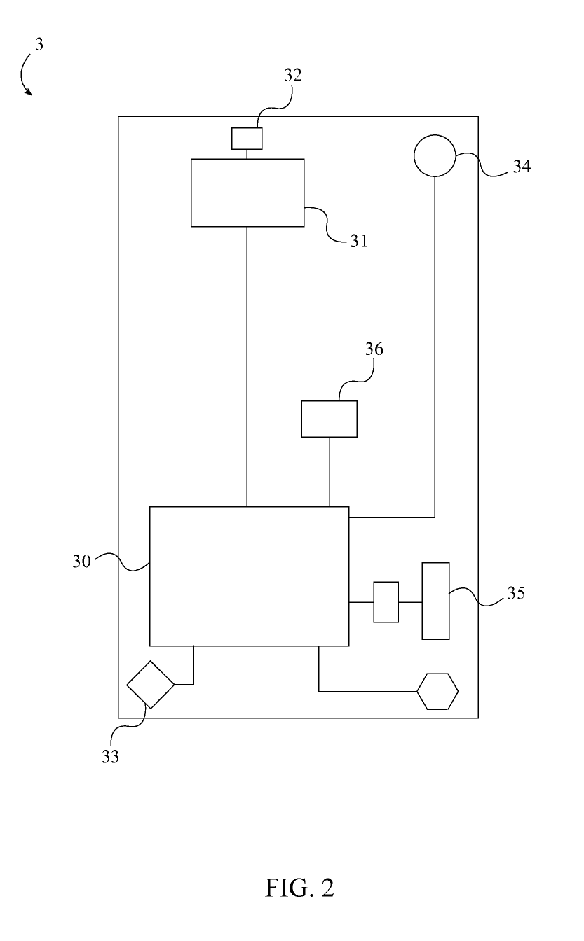

Each of the plurality of PRTs 3 operates independently, wherein the plurality of PRTs 3 may be scalable on demand to be wither a homogenous, a heterogeneous, or a parallel multi-processor system. In reference to FIG. 2-3, each of the plurality of PRTs 3 comprises a processor unit 30, a dedicated NIC 31, a PRT storage 36, and a PRT memory 35. The processor unit 30 of each of the plurality of PRTs 3 is electronically connected to the GPP 10 of the FPT 1, while the dedicated NIC 31 of each of the plurality of PRTs 3 is electronically connected to the TOR switch 4 of the blade server system. In the preferred embodiment of the present invention, the PRT storage 36 is a non-volatile solid state storage system and the PRT memory 35 includes a memory and a memory controller. Each of the plurality of PRTs 3 may further include a component sensor and a plurality of components necessary for the operation of the PRT. Additionally, each of the plurality of PRTs 3 has a bus structure that internally connects the components of the PRT, a separate external bus that connects the PRT architecture to the I/O hub 13 of the FPT 1, and an individual independent power architecture.

Each of the plurality of PRTs 3 can process in parallel and independently from each other. The processor unit 30 for each of the plurality of PRTs 3 may be multi-processor, multi-core systems that may use different and sometimes incompatible ISA without leading to binary incompatibility, that may interpret memory in different ways and may have different ABIs and/or APIs. The processor unit 30 for each of the plurality of PRTs 3 may be of different processing capacity or of the same processing capacity. While several embedded independent heterogeneous and homogeneous PRTs may be embedded in the blade server architecture, the energy efficient blade server must include at least one PRT that it identifies as a default PRT from the plurality of PRTs 3.

As an example, the processor unit 30 for a PRT may include a processor; a sub-processor; a microprocessor; a multi-core processor; a digital signal processor; a digital logic; a field programmable gate array that executes operational instructions to perform a sequence of tasks; a general-purpose processor device; and a graphic processing unit (GPU) having a fixed form and whose functionality is variable, wherein this variable functionality is defined by fetching instructions and executing those instructions. The instructions can be stored in firmware or software and can represent anywhere from a very limited to a very general instruction set.

In reference to FIG. 3, the PRT architecture configuration allows direct, individual data transmission results from each of the plurality of PRTs 3 to the TOR switch 4. This direct connection is independent of the main blade server NIC (the dedicated TOR NIC 110) and results in a reduction of overhead and congestion associated with transmission between the FPT 1 and the TOR switch 4. As will be appreciated by those of ordinary skill in the art, with various examples of the invention, using the plurality of PRTs 3, each capable of executing independently and simultaneously, application processes, and each transmitting independently the resulting data to the TOR switch 4, results in an independent multi-processor parallel system on a single and same blade server.

In reference to FIG. 1, the PMCT 2 is integrated into the architecture of the FPT 1 and is an integral part of the FPT 1 architecture. As such, the FPT 1 and the PMCT 2 share a common power plane. The PMCT 2 comprises a main computing device 20, a tier power control (TPC) device 22, a virtual processing element (VPE) 21, and a plurality of monitoring components 23. The PMCT 2 has hardware management functions that are directed by a master control command (MCC) module, which is a software operated on the FPT 1. The PMCT 2 directs, through the main computing device 20 and as instructed by the MCC, process execution to the appropriate PRT from the plurality of PRTs 3 and ensures that the TPC device 22 powers up or powers down the selected PRT. The PMCT 2 also manages power supplied to the VPE 21 and provides the GPP 10 of the FPT 1 and the processor unit 30 of each of the plurality of PRTs 3 access to the VPE 21 when instructed by the MCC.

The PMCT 2 maintains each of the plurality of PRTs 3 in the power mode off state by default, unless instructed by the MCC module to switch to the power mode on state. The PMCT 2 powers on the plurality of PRTs 3 through the TPC device 22, wherein the main computing device 20 receives instructions from the MCC module and relays the instructions to the TPC device 22. As such, each of the plurality of PRTs 3 comprises a dedicated power plane that has selectable power modes. The dedicated power plane is triggered on or off by the TPC device 22, wherein the dedicated power plane dictates the supply of power to all of the components of the PRT. For example, when in the power mode on, power is supplied to the components of the PRT such as gateways connecting the PRT to the FPT 1 and the PMCT 2 architectures, their buses, the processor unit 30, the dedicated NIC 31, the PRT storage 36, and the PRT memory 35 through the dedicated power plane. Likewise, when in the power mode off, no power is supplied to any of the components of the PRT through the dedicated power plane.

Upon the dedicated power plane of the PRT being switched to the power mode on, the PRT goes through latency wake up cycles. Once the PRT has gone through the latency wake up cycles, the TPC device 22 notifies the main computing device 20 of the PMCT 2 that the PRT is ready to compute and transmit data. The main computing device 20 then in turn notifies the MCC module running on the FPT 1 that the PRT is ready to compute and transmit data.

The instruction that triggers the TPC device 22 to change the power state to the power mode on or the power mode off for the dedicated power plane of a specific PRT is issued by the MCC module to the main computing device 20 of the PMCT 2 that will in turn instruct the TPC to trigger the power mode on or the power mode off. Once the powering on or off of the dedicated power plane is completed, the TPC device 22 goes on standby and waits for another power on or off instruction. Once the dedicated power plane of the PRT architecture has been switched to the power mode on, the PRT can have several other power modes that can vary according to the application requirements and are dependent on the integrated processor component specifications of the processor unit 30. The other power modes can be, as dictated through the MCC module and the PMCT 2, any of the following: “active mode” such as throttled up mode, thereby in a high-power mode, or a “sleep mode” or a “deep sleep” mode or “standby” mode, thereby in a low-power mode.

In addition to powering on and off the plurality of PRTs 3, the TPC device 22 is also used to power on and off the VPE 21. As such, the VPE 21 is electronically connected to the TPC device 22. Similar to the plurality of PRTs 3, the VPE 21 is by default in the power mode off, wherein the VPE 21 is switched to the power mode on by the TPC device 22 following an instruction sent from the MCC module to the PMCT 2. The VPE 21 is a reconfigurable co-processor accelerator that is used for a reconfigurable computing accelerator (RCA) function of the present invention. The RCA function provides, through the system interface of the VPE 21, a sub-processor computing resource that may be a co-processor accelerator and/or an application specific instruction set processor (ASIP) to the processor unit 30 of each of the plurality of PRTs 3 and/or the GPP 10 of the FPT 1. The VPE 21 may have one processor core, or several cores that are architecturally different processor cores both in number and in type, have different instruction sets, and have different bit address segmentations.

In the preferred embodiment of the present invention, it is one of the purposes of the VPE 21 to process standard relevance ranking algorithms for other sub-processors (i.e. the processor unit 30 of each of the PRTs or the GPP 10 of the FPT 1). Such standard relevance ranking algorithms may include, but are not limited to, PageRank and the rank boost algorithm; other types of algorithms such as a fast Fourier transform (FFT) and complex matrices; and highly repetitive algorithms, such as those used by web search engines, or such as data encryption, advanced encryption, stemming, and tokenization. In this RCA configuration, the VPE 21 interface would select the high-speed bus I/O connecting the VPE 21 to the requesting PRT or the FPT 1. By providing additional processing computing resources through the VPE 21, the energy efficient blade server becomes faster, a more effective computation resource, and has a higher green efficiency level when computing computer intensive functionalities. Furthermore, the VPE 21 enables flexible addition, or reassignment of child processes from the plurality of PRTs 3 and the GPP 10 of the FPT 1.

The plurality of monitoring components 23 of the PMCT 2 is utilized to monitor the hardware and operations of the plurality of PRTs 3 and the FPT 1. The plurality of monitoring components 23 is electronically connected to the main computing device 20 and, in the preferred embodiment of the present invention, an analog-to-digital converter (ADC) 232, a clock generator 230, and a voltage regulator 231. The ADC 232 and the voltage regulator 231 are used to collect temperatures, fan speeds, and voltage levels of the plurality of PRTs 3 and the FPT 1, and transmit the data to the SOM controller 112, wherein the data is stored by the data center operating system. The data can be sent from the SOM controller 112 to the data center operating system via the Advanced Configuration and Power Interface protocol, or a similar protocol. Additionally, the data is sent to the MCC module and can be stored in the FPT storage 15 or the common computer readable storage medium 5. The clock generator 230 allows the PMCT 2 to generate clock signals to permit PRT clock frequency changes, thereby allowing clock-gating power management schemes in subsequent versions of the present invention.

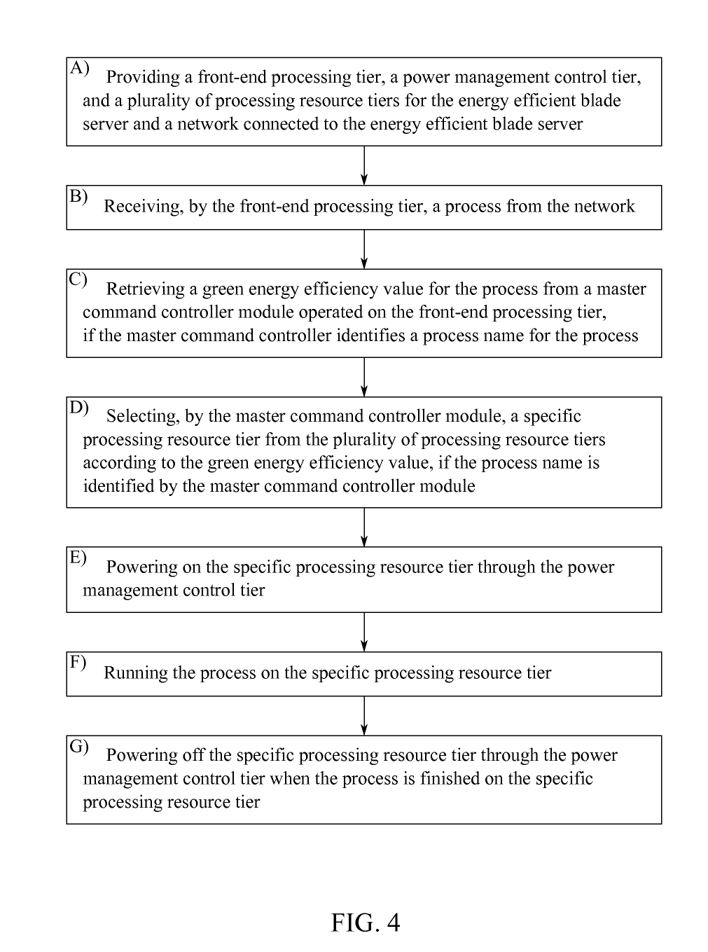

In reference to FIG. 4, the MCC module determines and dictates to the PMCT 2 the specific PRT from the plurality of PRTs 3 that should be switched to the power mode on. This is accomplished by identifying the process received by the FPT 1 and determining a green energy efficiency value for the process. The green energy efficiency value is then used by the MCC module to direct the process to the appropriate PRT from the plurality of PRTs 3. By determining the green energy efficiency value for each process directed to the energy efficient blade server, the present invention is able to provide a maximum performance execution of data center applications while maintaining the best possible greenest energy efficiency during said execution.

The MCC module comprises three sub-modules that are utilized to identify the process, determine the green energy efficiency value of the process, and appropriately route the process. More specifically, the MCC module comprises a MCC-monitor sub-module, a MCC-predictor sub-module, and a MCC-scheduler sub-module. The MCC-monitor sub-module identifies the process and relays the information to the MCC-predictor sub-module. The MCC-predictor sub-module then determines the green energy efficiency value for the process and matches the process to the specific PRT. The MCC-predictor sub-module then relays identity information for the specific PRT to the MCC-scheduler sub-module, wherein the MCC-scheduler sub-module commands the PMCT 2 to power on the specific PRT through the TPC device 22.

The green energy efficiency value is a weighted value generated by a green energy predictor (GEP) scheme that defines the best possible and greenest energy performance of a given PRT from the plurality of PRTs 3 for a given process and any sub-processes of the given process. The GEP scheme is based on an expression that combines the shortest length of time it takes a PRT to execute a process, the least amount of heat dissipated by a PRT during process execution, and the least amount of electricity or electrical energy used by a PRT during the process execution. Using the GEP scheme, the present invention is able to determine the green energy efficiency value used to match each process with the most appropriate PRT. The GEP scheme is used to create a GEP table that is stored in the FPT storage 15, wherein the GEP table holds the energy efficiency value for a plurality of processes.

The MCC-predictor sub-module manages API executions for the plurality of PRTs 3 according to a schedule that maximizes fitness function that comprises multiple objectives and versatility. Data collected by the PMCT 2 for each process is separated into two types of data banks and used to predict the green energy efficiency value for a process. More specifically, the data collected by the PMCT 2 is separated into a data hardware bank and a data software bank that is then used in the GEP scheme. The data hardware bank is broadly built on, but not limited to, the electrical consumption of the plurality of PRTs 3, temperature of the plurality of PRTs 3 such as heat dissipation, and the frequency of operations of the plurality of PRTs 3. The data software bank is composed of, without being limited to, executed APIs and application code profiling.

The data collected for the data hardware bank and the data software bank is compiled over a configurable time period in order to take into account applications' static and dynamic profiles. The data hardware bank and the data software bank can be used jointly or separately depending on the application and hardware or the PRT used. The goal of the MCC-predictor sub-module is to estimate at instant t(n+m) the application and power consumption that need to be executed on the plurality of PRTs 3 from the available data inferior to t(n), where t represents time, n the sampling instant, and m the sampling number, where n and m are whole numbers greater than zero. The MCC-predictor sub-module and the MCC-scheduler sub-module are built by a processing channel that comprises a data pre-processing, an analysis and extraction of discriminant parameters, a classification and scheduling, and a decision and control on the plurality of PRTs 3 and the PMCT 2.

The data pre-processing consists of removing data imperfections, noises and artefacts from the data hardware bank that could contaminate the data necessary for ensuing data processing. This removal is done via methods that include, but are not limited to, applying filters based on predetermined times and frequencies, as well as applying adaptive filters. Examples of filters include detection of the frequential and temporal features using FFT analysis; an adaptive filter such as the least mean squares (LMS) algorithm used to mimic a desired filter by finding the filter coefficients that relate to producing the least mean squares of the error signal; recursive least square (RLS); the Kalman filter (a.k.a. linear quadratic estimation—LQE); wavelet-based methods; and nonlinear filters such as the Volterra filter, artificial neural networks (ANN), and fuzzy logic algorithms. These methods can be applied in a variety of ways; on a stand-alone basis or in combination with each other. The objective of the data pre-processing stage is to reorganize the data such that the data can be processed efficiently in the ensuing processing channel. This reorganization enables regrouping or splitting data structures in order to reduce complexity and improve the efficiency of the ensuing processing.

The analysis and discriminant parameters extraction of the data hardware bank and data software bank enables the extraction of data relating to the power consumption mapping characteristics, as well as the applications being executed by the PRT. Digital signal processing methods are used to highlight the discriminant parameters of the data hardware bank and the data software bank in order to extract the necessary information for decision making processes on what state the PRT power consumption should be at (several possible state are possible, e.g. 100%, 50%, 5%, or 0%), as well as the prediction for application execution on the PRT according to scheduling calculated at the next step. The analysis and discriminant parameters extraction methods used include, but are not limited to, wavelet transform methods, independent component analysis (ICA), ANN, fractal methods, and statistical data mining. These methods can be applied in a variety of ways; on a stand-alone basis or in combination with each other.

Once the discriminant parameters are extracted, the interpretation based on discriminant parameters and mapping results can be achieved in the classification and scheduling stage. The discriminant parameters alone are far too complex for a direct interpretation. Hence the process of classification and scheduling consists of matching a discriminant parameters data set to a defined class, while maintaining operations scheduling. The methods used depend on the nature of the information and the data sets (banks) available to determine the classification, wherein such methods include, but are not limited to, ANN, and a support vector machine (SVM). To optimize scheduling, the following metaheuristics (e.g. genetic algorithms, Artificial Bee Colony algorithm) are used on the basis of selective multi-objective functions (e.g. electrical consumption, latency, temperature, and computing time).

The decision and control on the plurality of PRTs 3 and PMCT 2 stage: Subsequent to the previous steps, a decision can be made on the forwarding of computing operations to the plurality of PRTs 3. Forwarding of the computing operations to the plurality of PRTs 3 is determined according to the schedule previously determined and the power consumption levels of each of the plurality of PRTs 3. The decision for directing the computing operations to the plurality of PRTs 3 is sent from the MCC-scheduler sub-module to the PMCT 2, wherein the PMCT 2 powers on the appropriate PRTs. The data that is collected and processed throughout the GEP scheme is stored on the FPT storage 15.

The following describes the arrangement and power connections of the FPT 1, the PMCT 2, and the plurality of PRTs 3 in the preferred embodiment of the present invention. In reference to FIG. 1 and FIG. 3, the GPP 10 is electronically connected to the FPT memory 14, the FPT storage 15, and the I/O hub 13; the FPT memory 14 being a RAM and the FPT storage 15 being a non-volatile solid state drive. Through the I/O hub 13, the GPP 10 is electronically connected to the common computer readable storage medium 5. The common computer readable storage medium 5 is also electronically connected to the main computing device 20 and the processor unit 30 of each of the plurality of PRTs 3 through the I/O hub 13. The GPP 10, the main computing device 20, and the processor unit 30 of each of the plurality of PRTs 3 is electronically connected to the common main memory 6 through a shared RAM bus 7.

In reference to FIG. 1, the plurality of NICs 11 of the FPT 1 is electronically connected to the GPP 10, allowing the GPP 10 to communicate with networks external to the energy efficient blade server. The dedicated TOR NIC 110 is electronically connected to the TOR switch 4 through a direct bus 16, allowing the GPP 10 to communicate with the data center network. The inter-server NIC 111 allows the GPP 10 to share the GEP data stored in the FPT storage 15 with an enclosure network consisting of the at least one subsequent energy efficient blade server 8 in the same rack as the energy efficient blade server. In this way, the GEP data stored on the energy efficient blade server or one of the at least one energy efficient blade server can be shared throughout the entire rack. The SOM controller 112 is electronically connected to the LAN port 12, such that the data center managers can communicate with the energy efficient blade server. Furthermore, the SOM controller 112 is electronically connected to the GPP 10 through the I/O hub 13.

In reference to FIG. 1 and FIG. 3, the GPP 10 of the FPT 1 is electronically connected to the main computing device 20 of the PMCT 2, wherein the MCC module can send instructions to the PMCT 2 to direct the TPC device 22. More specifically, the GPP 10 is electronically connected to the main computing device 20 through the I/O hub 13 and a PMCT gateway 24 of the PMCT 2, wherein a high speed bus connects the PMCT gateway 24 to the I/O hub 13 and the I/O hub 13 to the GPP 10. The main computing device 20 of the PMCT 2 is electronically connected to the plurality of monitoring components 23 and the TPC device 22, wherein the plurality of monitoring components 23 monitors system parameters that are then sent to the FPT 1 through the PMCT gateway 24 and stored on the FPT storage 15 as the GEP data. The VPE 21 is also electronically connected to and communicates with the GPP 10 through the PMCT gateway 24 and the I/O hub 13.

In reference to FIG. 1-2, while the processor unit 30 for each of the plurality of PRTs 3 may vary, the rest of the overall architecture of each of the plurality of PRTs 3 remains the same. The architecture for each of the plurality of PRTs 3 is separate from the architecture of the FPT 1 and the PMCT 2. For each of the plurality of PRTs 3, the dedicated power plane is switched between the power mode on and the power mode off through a high speed PRT to TPC bus that is electronically connected in between the TPC device 22 and each of the plurality of PRTs 3. Each of the plurality of PRTs 3 is also electronically connected to the VPE 21 through a first PRT gateway 33 and a high speed PRT to VPE 21 bus, and electronically connected to the GPP 10 through a high speed PRT to FPT 1 bus that is connected in between a second PRT gateway 34 and the I/O hub 13. For each of the plurality of PRTs 3, the processing unit is electronically connected to the dedicated NIC 31, the PRT storage 36, and the PRT memory 35. The dedicated NIC 31 for each of the plurality of PRTs 3 is in turn electronically connected to the TOR switch 4 through a high speed port 32 and a dedicated bus 37, providing each of the plurality of PRTs 3 with direct access to the data center network.

The following describes the method for reducing the power consumption of a data center using the energy efficient blade server in the preferred embodiment of the present invention. In reference to FIG. 4, the energy efficient blade server is connected to a network through the TOR switch 4, wherein a process is sent to the energy efficient blade server from the network through the TOR switch 4. The process is received from the TOR switch 4 by the FPT 1, through the dedicated TOR NIC 110. Upon receiving the process, the FPT 1 performs a power-on-self-test and a liveness test. The liveness test sets a current power state for the FPT 1, wherein the FPT 1 is always in the power mode on but has three power states; full power, standby, and low power. The full power state is accessed when the FPT 1 is processing, the standby state is a lower power state where the FPT 1 can react instantaneously to the process coming from the TOR switch 4, and the low power state is the lowest energy consumption state that requires more time to react. The liveness test switches the FPT 1 from the current power state to the next highest power state if applicable.

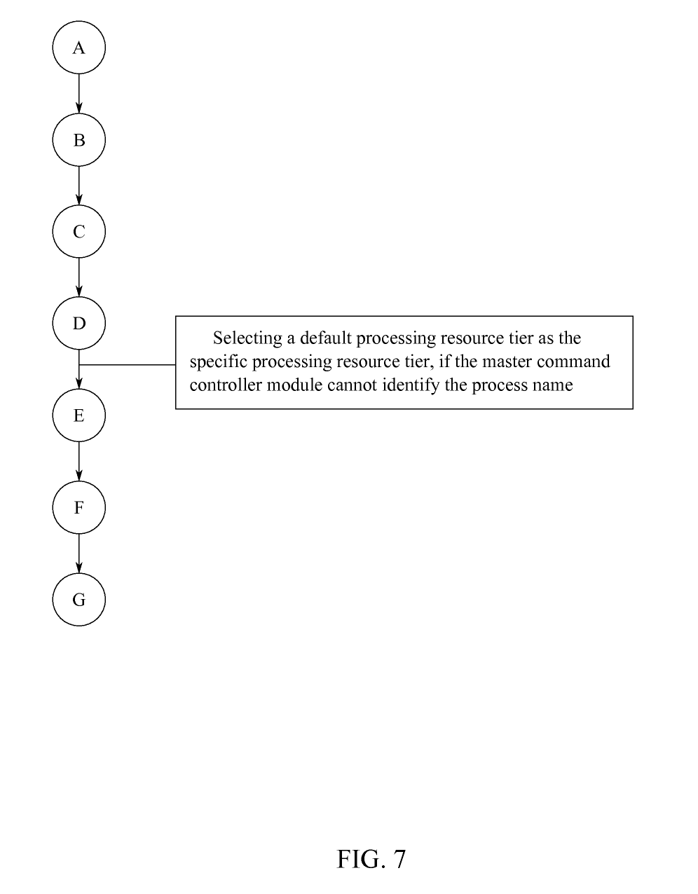

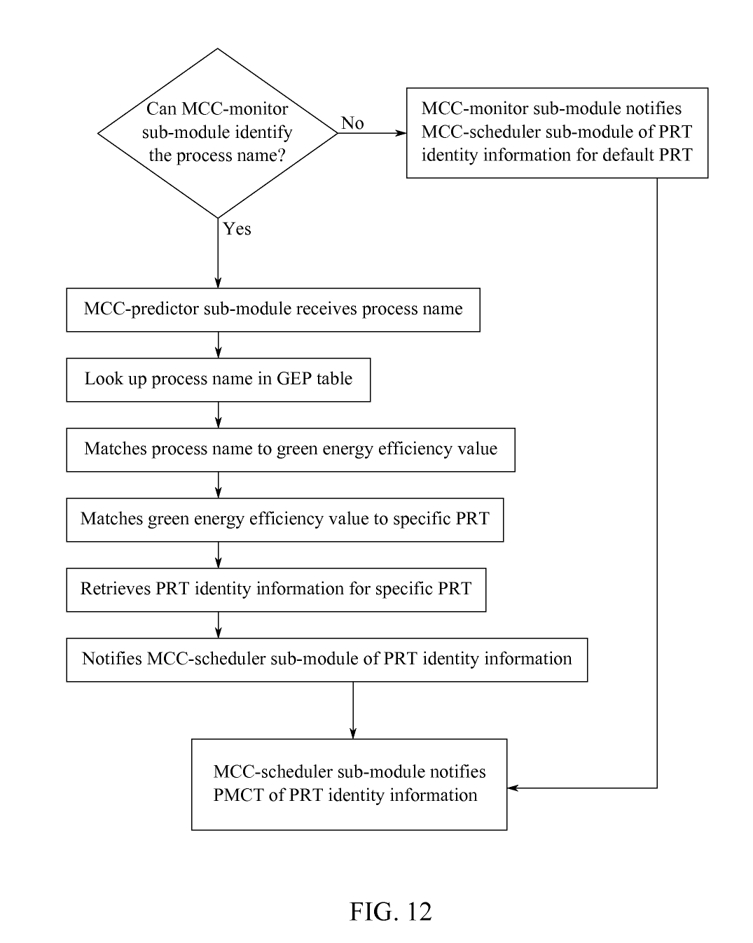

The PMCT 2 is then activated and performs a liveness test as well. The FPT 1 system boots and the operating system starts up, wherein the MCC module is then initiated and loaded into memory. The FPT 1 then runs any initial operating system tasks and the GEP table is loaded into memory. The FPT 1 then begins to process the process, wherein the MCC module attempts to determine the process name of the process. More specifically, the MCC-monitor sub-module attempts to identify the process name, as depicted in FIG. 12. In reference to FIG. 7 and FIG. 12, if the MCC-monitor sub-module cannot identify the process name, then the MCC-monitor sub-module selects a default PRT as the specific PRT to which the process is to be directed, wherein the MCC-monitor sub-module bypasses the MCC-predictor sub-module and directly notifies the MCC-scheduler sub-module.

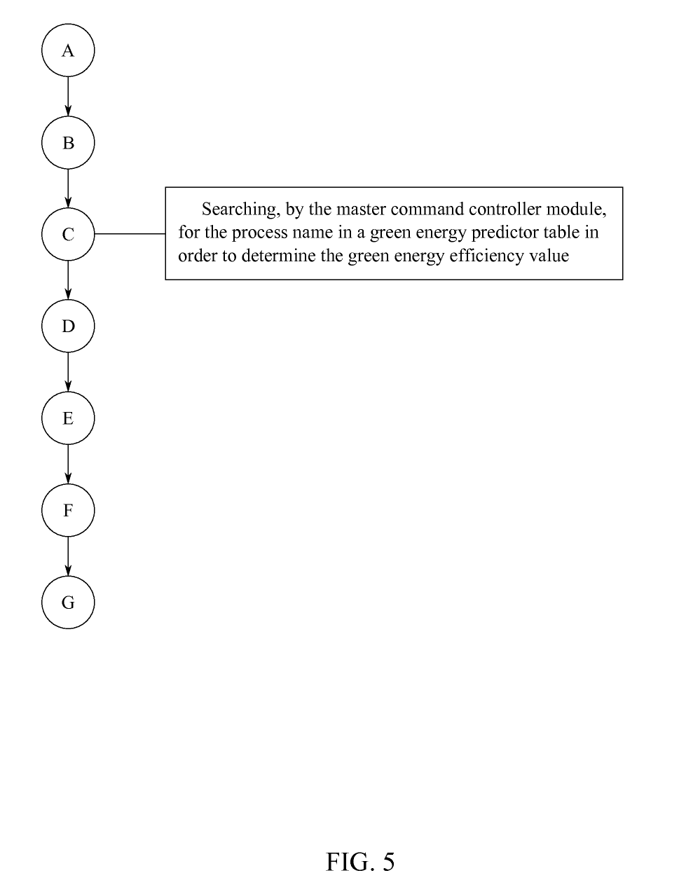

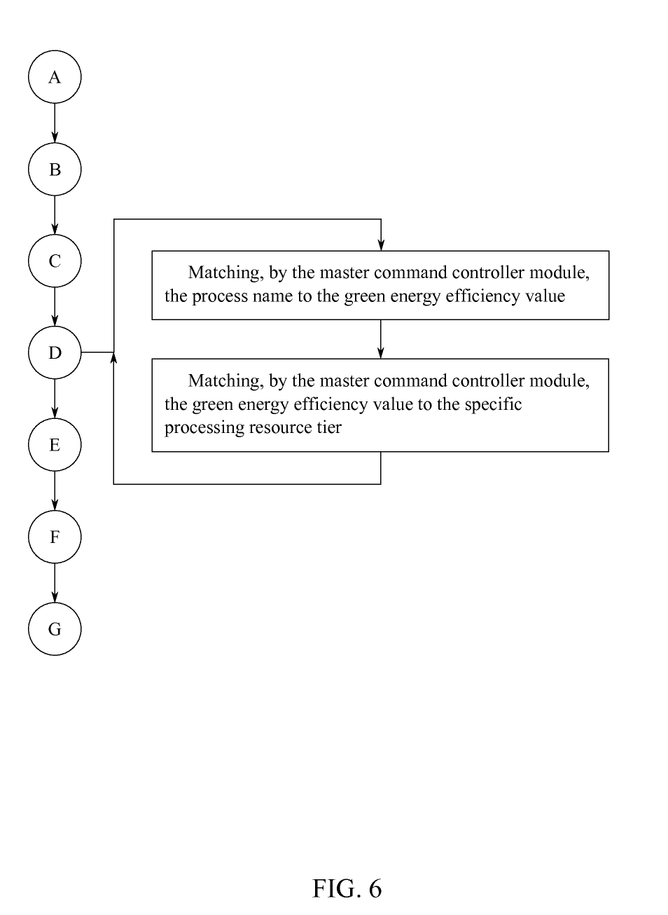

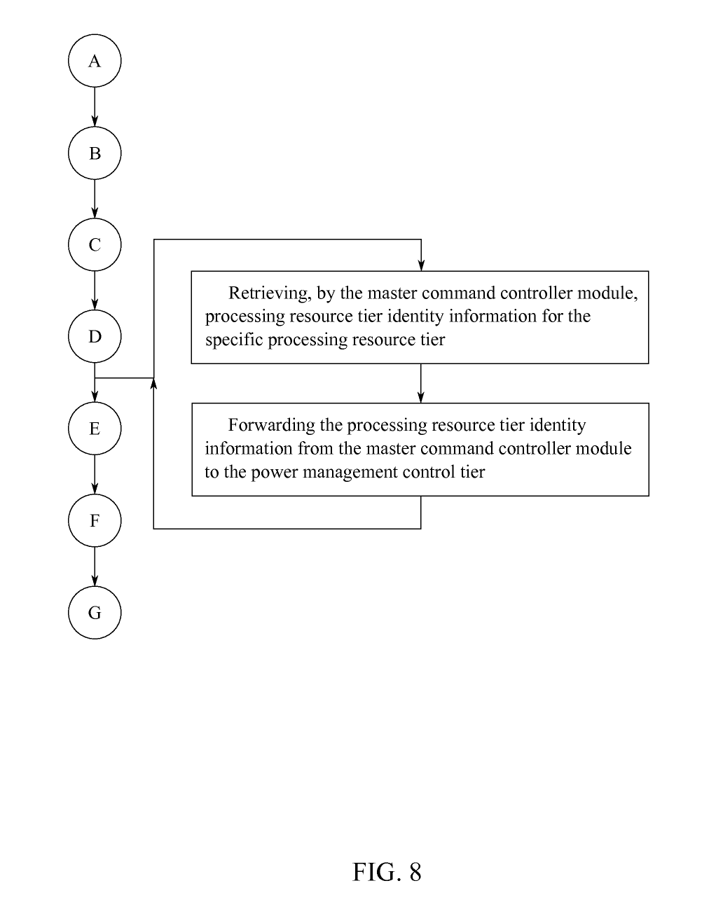

In reference to FIG. 4, if the MCC-monitor sub-module identifies the process name, then the green energy efficiency value for the process is retrieved by the MCC module and the MCC-predictor sub-module selects the specific PRT according to the green energy efficiency value. In reference to FIG. 12, the MCC-monitor sub-module transfers the process name to the MCC-predictor sub-module, and the MCC-monitor sub-module returns to monitoring the FPT 1 for any new processes. Upon receiving the process name, the MCC-predictor sub-module searches for the process name in the GEP table in order to determine the green energy efficiency value, as depicted in FIG. 5 and FIG. 12. The MCC-predictor sub-module matches the process name to the green energy efficiency value within the GEP table and then matches the green energy efficiency value to the specific PRT, as depicted in FIG. 6 and FIG. 12. The green energy efficiency value is matched to the specific PRT using the data collected by the plurality of monitoring components 23 and the available PRTs. In reference to FIG. 8 and FIG. 12, the MCC-predictor sub-module then retrieves PRT identity information for the specific PRT.

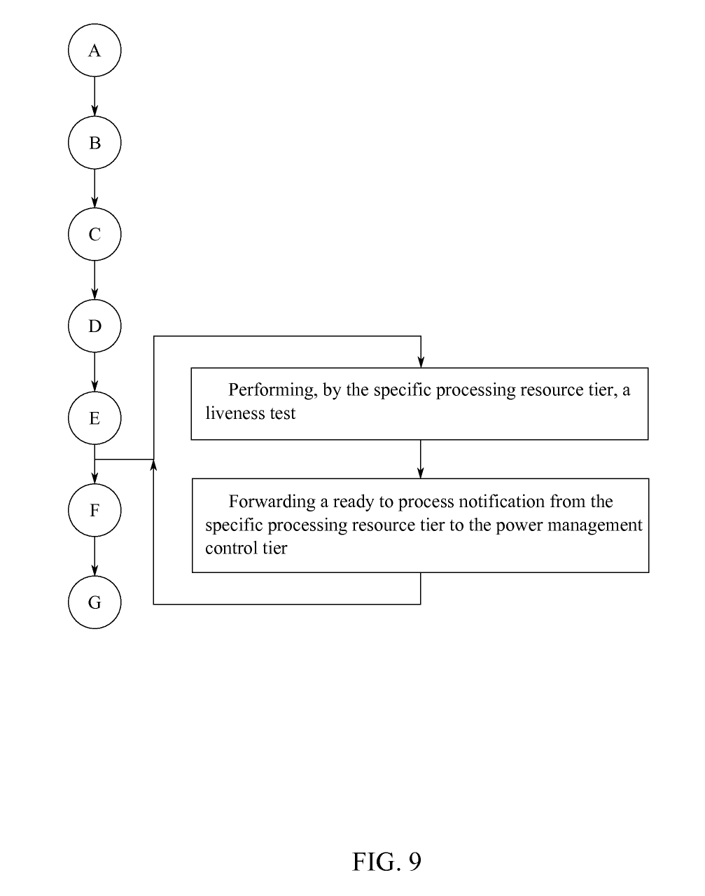

In further reference to FIG. 12, the PRT identity information is then forwarded from the MCC-predictor sub-module to the MCC-scheduler sub-module and the MCC-predictor sub-module goes idle waiting for any more incoming processes. In reference to FIG. 8 and FIG. 12, the MCC-scheduler sub-module then forwards the PRT identity information from the MCC module to the PMCT 2, wherein the PMCT 2 receives the PRT identity information and notifies the TPC device 22 to switch the dedicated power plane for the specific PRT to the power mode on. In reference to FIG. 4 and FIG. 9, the specific PRT is then powered on by the TPC device 22 of the PMCT 2, wherein the specific PRT first performs a liveness test upon being powered on. The liveness test for the specific PRT set the correct power mode for the process that is to be carried out on the specific PRT. Upon completing the liveness test, the specific PRT forwards a ready to process notification to the PMCT 2.

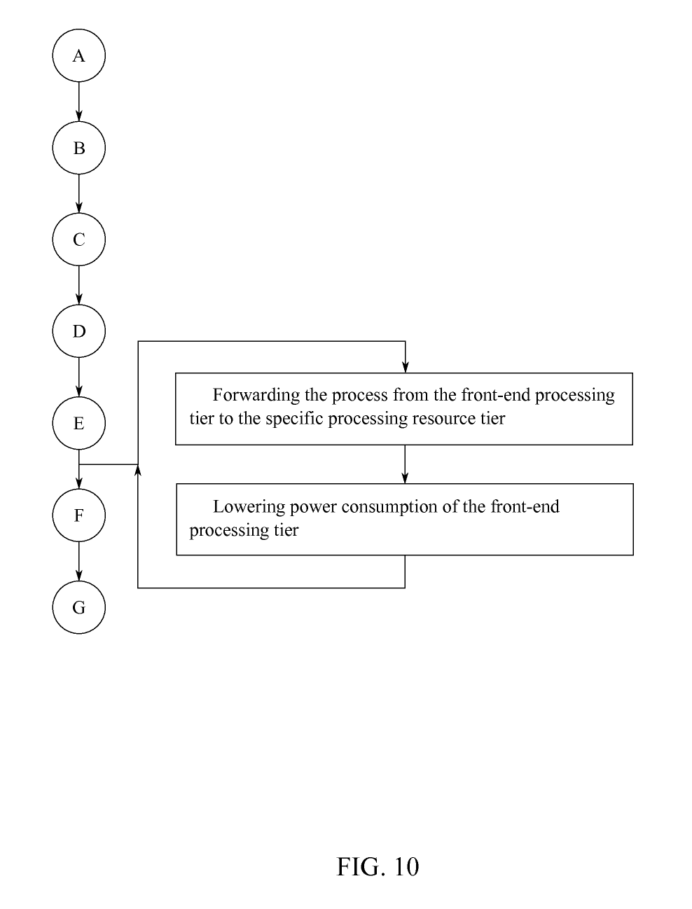

In reference to FIG. 10, once the PMCT 2 receives the ready to process notification, the process is forwarded from the FPT 1 to the specific PRT. The process is then run on the specific PRT, wherein the GPP 10 of the FPT 1 is freed from the process. The FPT 1 then drops to a lower power state and goes idle while waiting for other incoming processes, wherein power consumption of the FPT 1 is lowered. When the process has been completed, the specific PRT notifies the operating system of the FPT 1 and the MCC module. Additionally, the specific PRT can communicate the completed process directly with the network through the dedicated NIC 31 of the specific PRT that is connected to the TOR switch 4. The operating system then terminates the process and notifies the MCC module, wherein the MCC module notifies the PMCT 2 to power off the specific PRT.

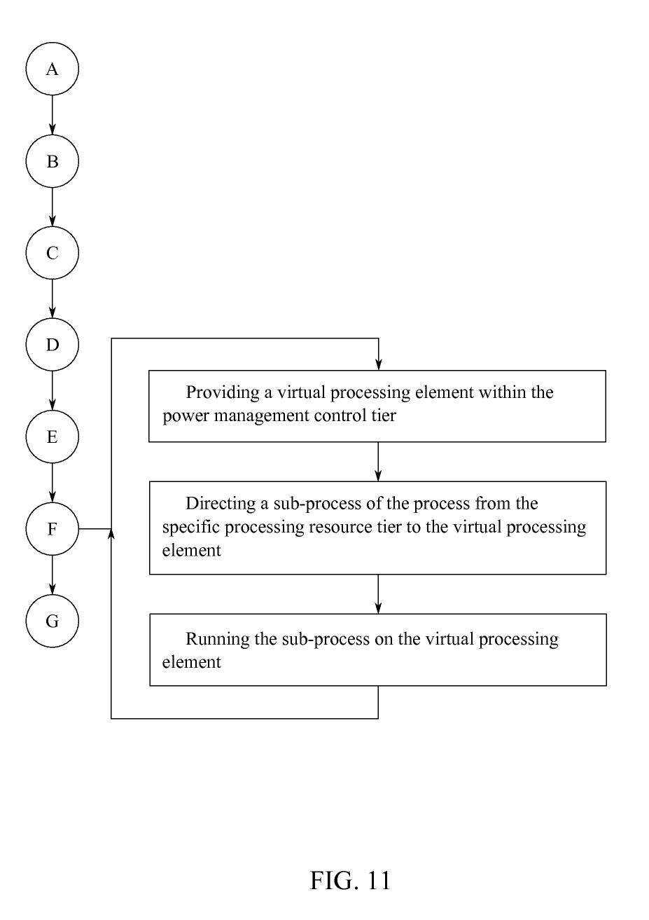

In reference to FIG. 11, while running the process on the specific PRT, it may also be necessary to power on the VPE 21 in order to run a sub-process of the process. The use of the VPE 21 is determined by an embedded code in the process ahead of the sub-process that needs to be transferred to the VPE 21. The embedded code advises or predicts to the specific PRT that the use of the VPE 21 will be required to be a particular function coming up in certain amount of time or in a certain number of lines. Upon accessing the embedded code, the specific PRT notifies the PMCT 2 to power on the VPE 21 and configure the VPE 21 to be a dedicated processor for the particular function. When the particular function arrives at the specific PRT in the certain time or the certain number of lines specified, the particular function is automatically transferred to the VPE 21, which is already prepared to process the particular function. Once the sub-process is directed from the specific PRT to the VPE 21, the sub-process is then run on the VPE 21.

The VPE 21 is typically used for reiterative functions that could bog down the processor unit 30 of the specific PRT, wherein the VPE 21 can be configured as a processor for any specific function located in the library of functions for the VPE 21. As an example, the library of functions for the VPE 21 may contain a FFT function. Depending on the complexity, the FFT could slow the delivery of the process if the FFT was executed on the processor unit 30 of the specific PRT. To avoid delays in the process delivery, and because the specific PRT is aware that there is a FFT in the library of functions for the VPE 21, the specific PRT will transfer the task of executing the FFT to the VPE 21. The VPE 21 then loads from the library of functions, the processor configuration of a dedicated FFT chip and will reconfigure the internal gates configuration of the VPE 21 to that of a dedicated FFT processor. The FFT is then processed in the VPE 21 and the results are transferred to the specific PRT, wherein the specific PRT receives the results and delivers the process to the network through the TOR switch 4. Ideally the VPE 21 is reconfigurable silicon, however, it is possible for the VPE 21 to take other forms.

Although the invention has been explained in relation to its preferred embodiment, it is to be understood that many other possible modifications and variations can be made without departing from the spirit and scope of the invention as hereinafter claimed.

What is claimed is:

1. An energy efficient blade server comprises:
a front-end processing tier;
a power management control tier;
a plurality of processing resource tiers;
the front-end processing tier comprises a general purpose processor;
the power management control tier comprises a main computing device and a tier power control device;
each of the plurality of processing resource tiers comprises a processor unit and a dedicated network interface controller;
the main computing device being electronically connected to the general purpose processor and the tier power control device;
the processor unit of each of the plurality of processing resource tiers being electronically connected to the tier power control device and the general purpose processor; and
the dedicated network interface controller being electronically connected to the processor unit for each of the plurality of processing resource tiers.

2. The energy efficient blade server as claimed in claim 1 comprises:
the front-end processing tier further comprises a plurality of network interface controllers; and
the plurality of network interface controllers being electronically connected to the general purpose processor.

3. The energy efficient blade server as claimed in claim 2 comprises:
a top-of-rack switch;
the plurality of network interface controllers comprises a dedicated top-of-rack network interface controller; and
the dedicated top-of-rack network interface controller being electronically connected to the top-of-rack switch.

4. The energy efficient blade server as claimed in claim 2 comprises:
an at least one subsequent energy efficient blade server;
the plurality of network interface controllers comprises an inter-server network interface controller; and
the inter-server network interface controller being electronically connected to the at least one subsequent energy efficient blade server.

5. The energy efficient blade server as claimed in claim 2 comprises:
a local area network port;
the plurality of network interface controllers comprises a smart out-of-band management controller; and
the smart out-of-band management controller being electronically connected to the local area network port.

6. The energy efficient blade server as claimed in claim 1 comprises:
the power management control tier further comprises a virtual processing element; and
the virtual processing element being electronically connected to the main computing device and the processor unit of each of the plurality of processing resource tiers.

7. The energy efficient blade server as claimed in claim 1 comprises:
a top-of-rack switch; and
the top-of-rack switch being electronically connected to the dedicated network interface controller of each of the plurality of processing resource tiers.

8. A method for reducing the power consumption of a data center using an energy efficient blade server by executing computer-executable instructions stored on a non-transitory computer-readable medium, the method comprises the steps of:
providing a plurality of processing resource tiers for the energy efficient blade server and a network connected to the energy efficient blade server;
receiving a process from the network;
retrieving a green energy efficiency value for the process,
if a process name is identified for the process;
selecting a specific processing resource tier from the plurality of processing resource tiers according to the green energy efficiency value,
if the process name is identified;
powering on the specific processing resource tier;
running the process on the specific processing resource tier; and
powering off the specific processing resource tier when the process is finished on the specific processing resource tier.

9. The method for reducing the power consumption of a data center using an energy efficient blade server by executing computer-executable instructions stored on a non-transitory computer-readable medium, the method as claimed in claim 8 further comprises the steps of:
searching for the process name in a green energy predictor table in order to determine the green energy efficiency value.

10. The method for reducing the power consumption of a data center using an energy efficient blade server by executing computer-executable instructions stored on a non-transitory computer-readable medium, the method as claimed in claim 8 further comprises the steps of:
matching the process name to the green energy efficiency value; and
matching the green energy efficiency value to the specific processing resource tier.

11. The method for reducing the power consumption of a data center using an energy efficient blade server by executing computer-executable instructions stored on a non-transitory computer-readable medium, the method as claimed in claim 8 further comprises the steps of:
selecting a default processing resource tier as the specific processing resource tier,
if the process name cannot be identified for the process.

12. The method for reducing the power consumption of a data center using an energy efficient blade server by executing computer-executable instructions stored on a non-transitory computer-readable medium, the method as claimed in claim 8 further comprises the steps of:
providing a virtual processing element within the power management control tier;
directing a sub-process of the process from the specific processing resource tier to the virtual processing element; and
running the sub-process on the virtual processing element.

13. A method for reducing the power consumption of a data center using an energy efficient blade server by executing computer-executable instructions stored on a non-transitory computer-readable medium, the method comprises the steps of:
providing a front-end processing tier, a power management control tier, and a plurality of processing resource tiers for the energy efficient blade server and a network connected to the energy efficient blade server;
receiving, by the front-end processing tier, a process from the network;
retrieving a green energy efficiency value for the process from a master command controller module operated on the front-end processing tier,
if the master command controller identifies a process name for the process;
selecting, by the master command controller module, a specific processing resource tier from the plurality of processing resource tiers according to the green energy efficiency value,
if the process name is identified by the master command controller module;
powering on the specific processing resource tier through the power management control tier;
running the process on the specific processing resource tier; and
powering off the specific processing resource tier through the power management control tier when the process is finished on the specific processing resource tier.

14. The method for reducing the power consumption of a data center using an energy efficient blade server by executing computer-executable instructions stored on a non-transitory computer-readable medium, the method as claimed in claim 13 further comprises the steps of:
searching, by the master command controller module, for the process name in a green energy predictor table in order to determine the green energy efficiency value.

15. The method for reducing the power consumption of a data center using an energy efficient blade server by executing computer-executable instructions stored on a non-transitory computer-readable medium, the method as claimed in claim 13 further comprises the steps of:
matching, by the master command controller module, the process name to the green energy efficiency value; and
matching, by the master command controller module, the green energy efficiency value to the specific processing resource tier.

16. The method for reducing the power consumption of a data center using an energy efficient blade server by executing computer-executable instructions stored on a non-transitory computer-readable medium, the method as claimed in claim 13 further comprises the steps of:
retrieving, by the master command controller module, processing resource tier identity information for the specific processing resource tier; and
forwarding the processing resource tier identity information from the master command controller module to the power management control tier.

17. The method for reducing the power consumption of a data center using an energy efficient blade server by executing computer-executable instructions stored on a non-transitory computer-readable medium, the method as claimed in claim 13 further comprises the steps of:
selecting a default processing resource tier as the specific processing resource tier,
if the master command controller module cannot identify the process name.

18. The method for reducing the power consumption of a data center using an energy efficient blade server by executing computer-executable instructions stored on a non-transitory computer-readable medium, the method as claimed in claim 13 further comprises the steps of:
providing a virtual processing element within the power management control tier;
directing a sub-process of the process from the specific processing resource tier to the virtual processing element; and
running the sub-process on the virtual processing element.

19. The method for reducing the power consumption of a data center using an energy efficient blade server by executing computer-executable instructions stored on a non-transitory computer-readable medium, the method as claimed in claim 13 further comprises the steps of:
forwarding the process from the front-end processing tier to the specific processing resource tier; and
lowering power consumption of the front-end processing tier.

20. The method for reducing the power consumption of a data center using an energy efficient blade server by executing computer-executable instructions stored on a non-transitory computer-readable medium, the method as claimed in claim 13 further comprises the steps of:
performing, by the specific processing resource tier, a liveness test; and
forwarding a ready to process notification from the specific processing resource tier to the power management control tier.
